(19) United States
(12) Patent Application Publication
(10) Pub. No.: US 2021/0251190 A1
(43) Pub. Date: Aug. 19, 2021

(54) ROPE PET TOY

(71) Applicant: Paula Rae Kidwell, Arvada, CO (US)

(72) Inventor: Paula Rae Kidwell, Arvada, CO (US)

(21) Appl. No.: 16/792,165

(22) Filed: Feb. 14, 2020

(51) Int. Cl. A01K 15/02

(52) U.S. Cl. CPC A01K 15/025

(57) ABSTRACT

The invention is a pet toy that has a plush body and a single piece of rope which weaves through turned construction channels in the body that maintains the toy's shape while still allowing it to be pliable. No unnecessary pieces are used that may become dislodged and pose a choking hazard. A single knot at the end of the rope allows the material to fray below the knot to serve as a dental cleaning portion as well as a tugging end a pet can pull on but not remove from the toy's body.

### FIELD

The present invention relates generally to stimulating, encouraging and motivating games and methods of playing regarding pets, e.g. dogs and cats. More particularly, the invention relates to motivational games, toys and methods for assessing the pet training skills in the form of games or puzzles that incite pet interaction and memory skills.

### PRIOR ART

There are many types of pet toys on the market that squeak or that can be used in a tug-of-war game between an owner and a dog, or multiple dogs without their owner's interaction. This novel toy is designed to provide pets of all sizes an appealing interaction with the toy and a durable single-piece rope design that also makes the toy safer as being without a lot of small pieces that may pose choking hazards when dislodged from the toy.

### BRIEF DESCRIPTION OF THE INVENTION

The novel design of the inventive toy provides a single piece of rope to be woven through a plush character body wherein the toy is sturdy, has no small parts that may present a choking hazard, and provides some dental benefit as well. Creating slits through the plush body of the toy allows the rope to be woven through much like a shoelace wherein this weaving makes the toy pliable yet hold its basic shape without additional parts that may dislodge and create a choking hazard. The edges of the slits are embroidered to avoid fraying.

The object of the present invention is to motivate and maintain interest of a pet. The toy is comprised of a single length of nylon or poly rope that is woven through an open-turned head and body channel which is a plush outer piece in the shape of an animal or fantasy character such as a unicorn. The rope is set at the bottom of the outer body and is knotted to prevent the rope from pulling through, and to also allow for the end of the rope below the knot to become “frayed” as a pet plays with the toy. This frayed end provides a section of rope that will easily “floss” the teeth of a pet in a manner similar to human dental floss.

The single piece of rope is looped at the top or head of the plush character for a tugging portion. The head of the character is turned construction with polyfill and a noisemaker such as a reed squeaker either alone or in combination with a crinkle material to further attract the pet. Facial features can be embroidered or printed on the face of the character. Arms or legs of a character are pieced construction set to the body and may also contain squeakers or crinkle material. The single length of rope in one embodiment is woven through openings or slits in the character body to form additional loops of rope to be on the outside of the character for gripping or tugging by the pet.

### BACKGROUND OF THE INVENTION

The invention most closely corresponds with USPTO Class 119/707 wherein Class 119 relates to animal husbandry and sub-class 707 includes toys.

In its simplest form, the invention relates to a novel toy for pets wherein a pet can play with the toy by itself or play a “tug of war” game with a pet owner. Unlike most rope toys on the market, the inventive toy is made with a single piece of rope. This aids in durability and reduces hazards wherein multiple pieces may be chewed and swallowed by a pet. The head, arms, legs and/or paws of a character can contain squeakers, noisemakers and a crinkle material that keep a pet entertained when it chews those sections.

### THE INVENTION

### Summary, Objects and Advantages

It well known that pets do experience a sense of boredom, and if not addressed, may manifest in negative behavior such as chewing furniture or going to the bathroom in undesirable locations in the pet owner's home. The inventive toy is designed to capture and retain a pet's interest whether the pet owner is away or home. The streamline design of a single piece of rope makes this toy durable and easier to manufacture than most prior art rope toys.

### BRIEF DESCRIPTION OF THE DRAWINGS

The invention is described in further detail by reference to nine (9) drawings sufficient in detail to describe the invention in which:

FIG. 1 is an illustration a unicorn toy with rope woven through the body and the knotted tail section;

FIG. 2 is an internal view of the unicorn toy showing the rope and squeakers;

FIG. 3 is a front view of an alligator character;

FIG. 4 is a rear view of the alligator character;

FIG. 5 is an internal view of the alligator again showing the rope looped though the body and squeakers in the extremities;

FIG. 6 is an example of a dragon embodiment;

FIG. 7 shows the front outer side of the dragon again demonstrating the looped rope and knotted tail;

FIG. 8 illustrates the internal section of the dragon with a squeaker and fins; and

FIG. 9 illustrates the type of circular reed squeaker used in all embodiments.

### DETAILED DESCRIPTION, INCLUDING BEST MODES OF CARRYING OUT THE INVENTION

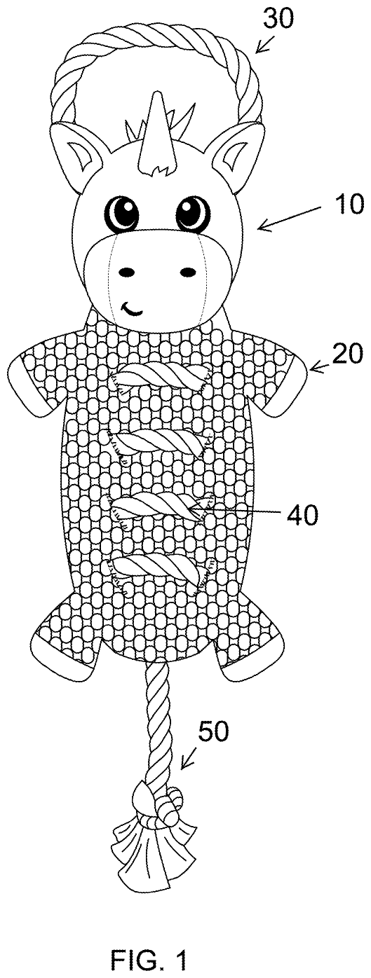

FIG. 1 shows the plush head 10 and body 20 of the unicorn toy embodiment. A looped rope half circle 30 extends through an open turned channel that extends the vertical length of the outer plush section. The next section of the single-piece rope is woven through the body of the toy 40 to both keep the toy pliable but to also aid in retaining its shape without extra pieces or sewing which may become dislodged. At the end of the rope piece is a single knot 50 which keeps the rope from pulling through the body and also serves to allow a section of rope to become frayed for dental cleaning during play.

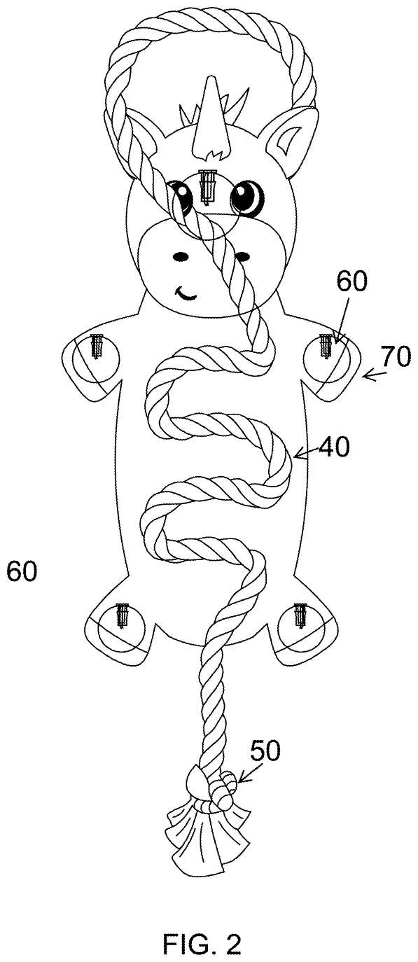

FIG. 2 is a cutaway of the unicorn showing the single piece of rope 40 as it winds through the body of the character. Squeakers 60 are located in the feet of the toy. Additionally, a crinkle material may be placed within the feet in addition to the squeakers or in lieu thereof. The knotted end 50 of the rope section extends out the bottom of the body through an open turn channel as in the head of the toy. The weaving of the rope keeps it inside of the toy and the knot and loop prevent the rope from being pulled from the body channel.

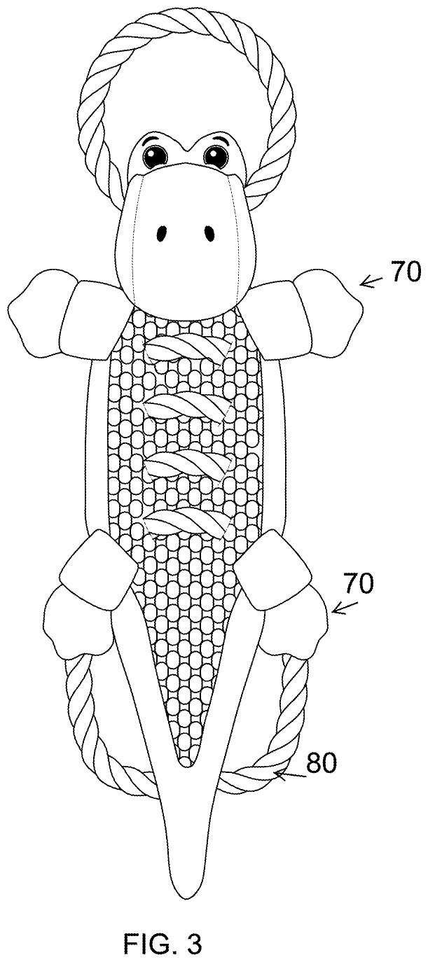

FIG. 3 is an example of an alligator character. The head and body are still plush and contain an open turned channel for the rope to wind through. Again feet 70 are shown and may be a felt fabric and contain a crinkle material or squeakers to entice the pet. The feet are turn seamed construction and will not easily detach from the body making the toy safer without multiple pieces. The alligator tail is shown as a loop embodiment wherein the rope may contain a loop at the top and bottom 80 of the toy for gripping.

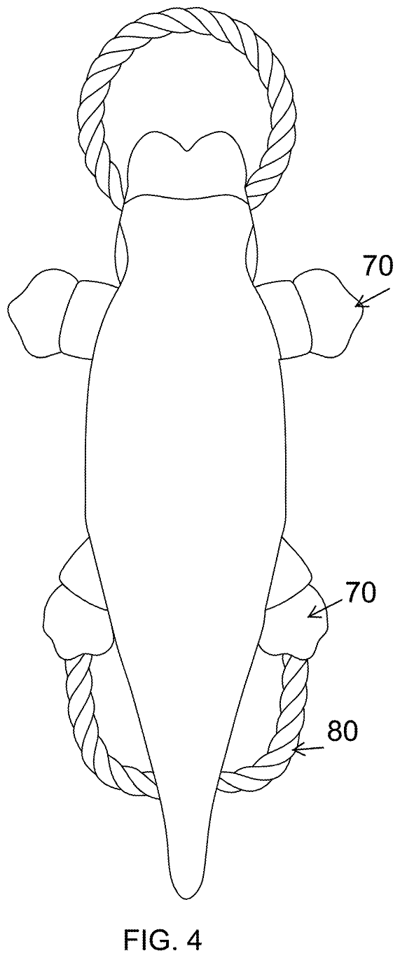

FIG. 4 is a rear view of the alligator with the feet 70 and rope loop 80 visible. The body is a plush fabric with turn seam construction and does not contain pieces that may be dislodged from the toy and pose a choking hazard.

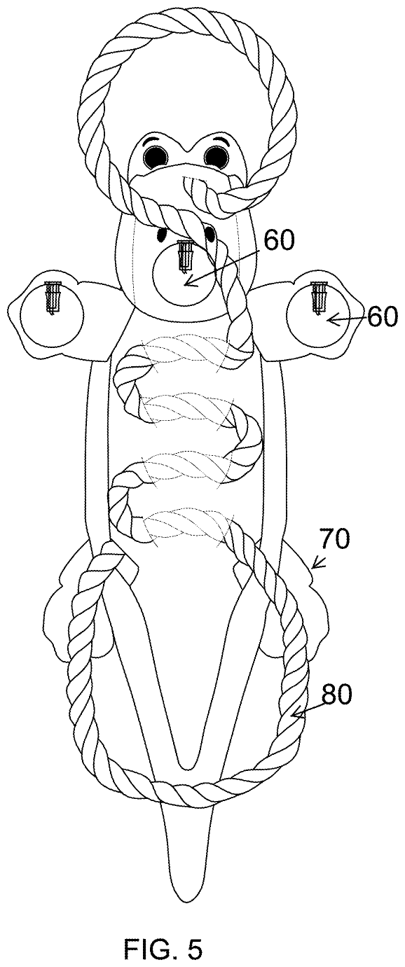

FIG. 5 illustrates the internal section of the alligator body. Again, the single piece of rope winds through the open turned channels and the weaving itself helps retain the toy's shape as well as pliability without additional seaming or grommets to keep the rope in place. Squeakers 60 are shown located inside the head and the feet 70 of the toy.

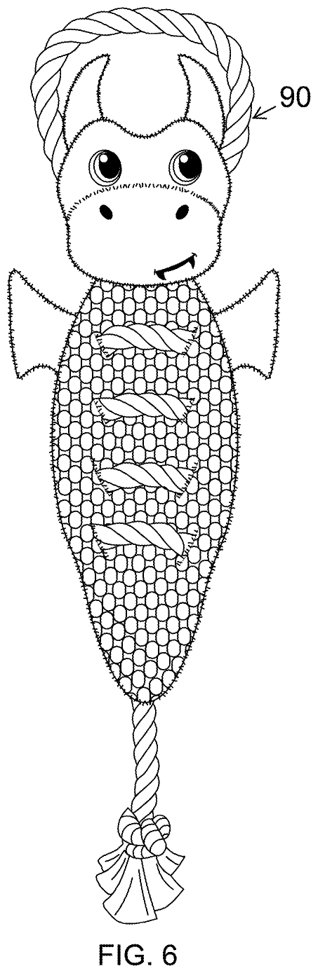

FIG. 6 shows a dragon character with the same single piece knotted rope as on the unicorn character. It is evident that the rope configuration can be applied to multiple outer plush characters which may also contain squeakers or crinkle material to further entice a pet to play.

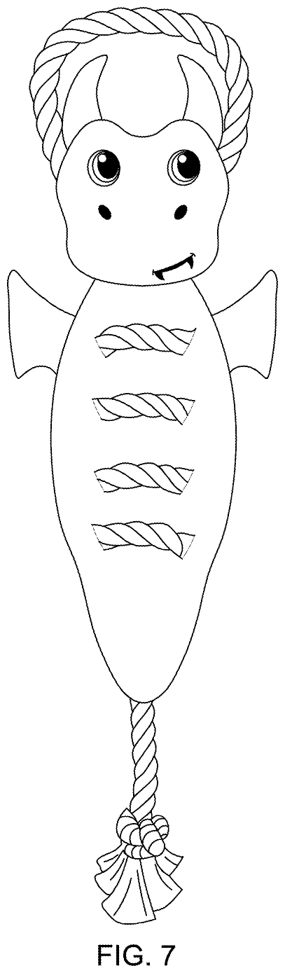

FIG. 7 illustrates the winding rope 40 which weaves through turn seam slits in the plush fabric, and further illustrates the absence of additional pieces to guide or connect the rope to the toy.

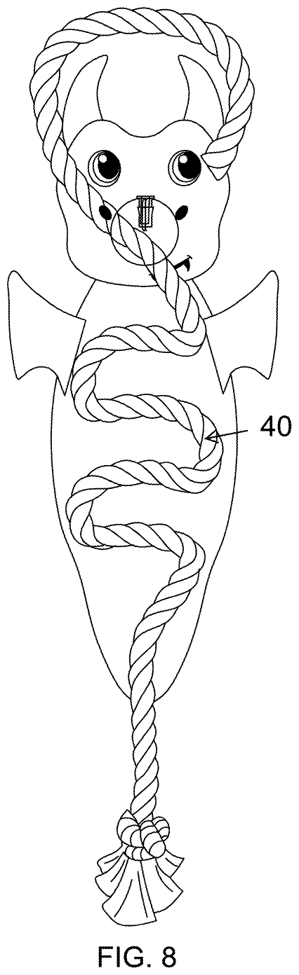

FIG. 8 illustrates the path of the rope within the toy body, again showing a single piece of rope 40 with a knotted end 50 which is allowed to fray below the knot and provide a dental aid which helps clean the pet's teeth when it chews on the frayed portion.

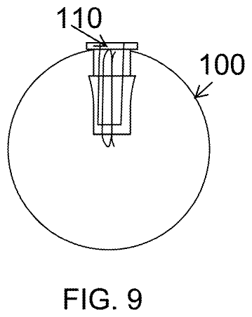

FIG. 9 is an illustration of the round squeakers 60/100 with a tuned reed 110 which may be placed in the head or feet of any character.

1) A pet toy comprising:
a) A single length of nylon or poly rope woven through a plush fabric outer body in the shape of an animal or other character depiction;
b) Open turned construction channels located in the top and bottom of the plush body;
c) Two piece turned construction forming turned open channels or slits though which the rope weaves along the length of the plush body;
d) A single knot at the end of the rope;
e) A loop of rope extending from the top or head of the plush body; and
f) Feet of the character which can contain squeakers or crinkle material.

2) A pet toy as in claim 1 wherein the rope is a single piece.

3) A pet toy as in claim 1 wherein the rope weaves through the head or top of the character through open turned construction channels which allow the rope to move freely through the channels but not being removable therefrom.

4) A pet toy as in claim 1 wherein the weaving of the single piece of rope traverses across the plush body of the toy in a shoelace configuration wherein the rope weaves from side to side in the body but is not removable therefrom.

6) A pet toy as in claim 1 wherein the end of the single rope piece is once knotted and will thus prevent the rope from slipping through the channels in the body of the toy, and wherein the section of rope below the knot is frayed to provide a dental chewing section which will clean pet teeth during chewing but will not further fray above the knot.

7) A pet toy as in claim 1 wherein toy characters can have feet or other appendages turn seamed constructed to the plush body and which appendages can contain squeakers or crinkle material to entice a pet.

8) A pet toy wherein a single length of nylon or poly rope is woven through a plush fabric outer body in the shape of an animal or other character depiction via open turned construction channels located in the top and bottom of the plush body wherein a loop of rope extends from the head and weaves through turned open channels or slits crisscrossing the body and wherein the rope ends in a loop extruding from an open channel in the bottom of the toy.
